(19) United States
(12) Patent Application Publication
(10) Pub. No.: US 2015/0158987 A1
(43) Pub. Date: Jun. 11, 2015

(54) CELLULOSE ACYLATE FILM, POLARIZING PLATE AND LIQUID CRYSTAL DISPLAY DEVICE

(71) Applicant: FUJIFILM Corporation, Tokyo (JP)

(72) Inventors: Hirofumi TOYAMA, Kanagawa (JP); Shinya WATANABE, Kanagawa (JP); Shusuke ARITA, Kanagawa (JP); Mitsutoshi TANAKA, Kanagawa (JP)

(73) Assignee: FUJIFILM Corporation, Tokyo (JP)

(21) Appl. No.: 14/619,500

(22) Filed: Feb. 11, 2015

Related U.S. Application Data
(63) Continuation of application No. PCT/JP2013/075968, filed on Sep. 26, 2013.

(30) Foreign Application Priority Data
Sep. 28, 2012 (JP) 2012-215985

(51) Int. Cl. C08J 5/18; G02B 5/30; G02B 1/14; G02F 1/1335

(52) U.S. Cl. CPC C08J 5/18; G02F 1/133528; G02B 5/3033; G02B 1/14; C08J 2301/02

(57) ABSTRACT

Provided is a cellulose acylate film that barely causes display unevenness when the cellulose acylate film is incorporated into a liquid crystal display. The cellulose acylate film includes a cellulose acylate having a total degree of acyl substitution of 2.0 to 2.35 and having a thickness of 20 to 39 μm. The film includes (Component 1) a sugar ester compound having one to six of at least one kind of pyranose and furanose structures, the OH groups of the pyranose and furanose structures being partially esterified with an aromatic organic acid (wherein the ratio A/B of the esterified rate A of the OH groups in the sugar ester compound to the acylated rate B of the OH groups in the cellulose acylate is 0.55 to 0.95); and (Component 2) an aromatic ester oligomer.

### CROSS-REFERENCE TO RELATED APPLICATIONS

This application is a Continuation of PCT International Application No. PCT/JP2013/075968 filed on Sep. 26, 2013, which claims priority under 35 U.S.C. §119(a) to Japanese Patent Application No. 2012-215985 filed on Sep. 28, 2012. The above application is hereby expressly incorporated by reference, in its entirety, into the present application.

### FIELD OF THE INVENTION

The present invention relates to a cellulose acylate film, a polarizing plate including the cellulose acylate film, and a liquid crystal display including the cellulose acylate film. Specifically, the invention relates to a cellulose acylate film that can be preferably used as an optical film, for example, a protective film of the polarizing plate or retardation film.

### PRIOR ART

In recent years, liquid crystal displays have been increasing used in TV sets and are required to achieve high resolution associated with an increase in screen size and to meet a further reduction in price. In particular, VA mode liquid crystal displays are most widely used in TV sets because of their relatively high contrasts and relatively high production yields. Such liquid crystal displays include polarizing plates, and as a protective film of such polarizing plates, cellulose acylate films are used (Patent Literature 1).

Incidentally, further reductions in thickness in the liquid crystal displays have been highly demanded in recent years. Accordingly, a reduction in thickness of the polarizing plate, which is a component of a liquid crystal display, is favorable.

### PATENT LITERATURE

[Patent Literature 1] International Publication No. WO2011/148869

### DISCLOSURE OF THE INVENTION

### Problems to be Solved by the Invention

The thickness of a polarizing plate may be reduced, for example, through a reduction in the thickness of a film mainly composed of a cellulose acylate (cellulose acylate film) which is a protective film of the polarizing plate. It may be considered that a cellulose acylate film having a relatively low degree of acyl substitution expresses a desired retardation (Rth) even in a small thickness. However, a film of a cellulose acylate having a low degree of acyl substitution has a risk of causing unevenness due to water condensation. Current liquid crystal displays are used in various environments all over the world and have a risk of water condensation on partial area of a surface of the film. If water condensation occurs on the surface, the water may permeate through the protective film of the polarizing plate and also the polarizing film to reach the retardation film. Moistened portions and unmoistened portions cause display unevenness, which is called unevenness due to water condensation.

It is an object of the present invention to solve these problems and to provide a thin cellulose acylate film that barely causes display unevenness when the cellulose acylate film is incorporated into a liquid crystal display.

### Means for Solving the Problems

Under such circumstances, the present inventors, who have diligently studied, have found that unevenness due to water condensation can be prevented with a film of a cellulose acylate having a low degree of acyl substitution and containing a predetermined sugar ester compound and an aromatic ester oligomer. In detail, in a film containing a cellulose acylate having a low degree of acyl substitution, water readily permeates into the film and spreads between cellulose acylate molecules to transmute the alignment of the additive molecules in the cellulose acylate film, and such transmutation causes irreversible changes in optical characteristics. In contrast, the use of a predetermined sugar ester and an aromatic ester oligomer achieves an appropriate Rth value in a thin film having excellent compatibility and barely causes unevenness due to water (water condensation). It is believed that the change can be prevented by the synergistic molecular interaction between cellulose acylate having a low degree of acyl substitution, the predetermined sugar ester, and the aromatic ester oligomer.

Specifically, the above-mentioned problems have been solved by the following aspect <1>, preferably aspects <2> to <10>.

<1> A cellulose acylate film comprising a cellulose acylate having an total degree of acyl substitution of 2.0 to 2.35 and having a thickness of 20 to 39 μm, the film comprising:

(Component 1) a sugar ester compound having one to six of at least one kind of pyranose and furanose structures, the OH groups of the pyranose and furanose structures being partially esterified with an aromatic organic acid (wherein the ratio A/B of the esterified rate A of the OH groups in the sugar ester compound to the acylated rate B of the OH groups in the cellulose acylate is 0.55 to 0.95); and

(Component 2) an aromatic ester oligomer.

<2> The cellulose acylate film according to <1>, wherein the sugar ester compound is sucrose benzoate having a degree of OH group substitution of 4 to 5 in the pyranose structure and the furanose structure.
<3> The cellulose acylate film according to <1> or <2>, wherein the cellulose acylate is cellulose acetate.
<4> The cellulose acylate film according to any one of <1> to <3>, which has an absolute value of 5 nm or less in Rth change at a wavelength of 550 nm after a water contact test,

wherein, in the water contact test, the film is immersed in water at 40° C. for 12 hours; waterdrops on the surfaces of the film are wiped off; and the film is dried in air and is then left to stand at 25° C. and 60% RH for 24 hours.

<5> The cellulose acylate film according to any one of <1> to <4>, wherein the aromatic ester oligomer is a compound of terephthalic acid and propylene glycol components, the compound having a molecular weight of 300 to 5000.
<6> The cellulose acylate film according to any one of <1> to <5>, further satisfying Formula (2):

100 nm≦Rth(550)≦300 nm Formula (2):

where, Rth(550) represents thickness-direction retardation at a wavelength of 550 nm.
<7> A polarizing plate comprising: a cellulose acylate film according to any one of <1> to <6>.
<8> A polarizing plate comprising: a cellulose acylate film according to any one of <1> to <6>; a protective film of the polarizing plate having a thickness of 10 to 40 μm; and a polarizer having a thickness of 3 to 20 μm disposed between the cellulose acylate film and the protective film of the polarizing plate, wherein the polarizing plate has a total thickness of 40 to 100 μm.
<9> A liquid crystal display comprising: a polarizing plate according to <7> or <8>.
<10> A liquid crystal display comprising: a polarizing plate according to <7> or <8>; and a glass plate having a thickness of 50 to 500 μm.

### Advantageous Effects of the Invention

The present invention can provide a cellulose acylate film that barely causes display unevenness when it is used in a liquid crystal display.

### BRIEF DESCRIPTION OF THE DRAWINGS

FIG. 1 is a schematic cross-sectional view illustrating the structure of a liquid crystal display produced in an example.

### EMBODIMENTS FOR CARRYING OUT THE INVENTION

The present invention will now be described in detail. The constituent elements may be described based on typical embodiments of the present invention, but such embodiments should not be construed to limit the present invention. It should be noted that, throughout the specification, any numerical Formulae in the style of “ . . . to . . . ” will be used to indicate a range including the lower and upper limits represented by the numerals given before and after the term “to”, respectively. Throughout the specification, the term “front side” refers to the display surface side, and the “rear side” refers to the backlight side. Throughout the specification, the term “front” refers to the normal direction against the display surface, and the term “front contrast (hereinafter, also referred to as CR)” refers to the contrast calculated from the white brightness and the black brightness measured in the normal direction to the displayer surface.

### <Cellulose Acylate Film>

The cellulose acylate film of the present invention contains a cellulose acylate having a total degree of acyl substitution of 2.0 to 2.35, has a thickness of 20 to 39 μm, and further contains the following two components: (Component 1): a sugar ester compound having one to six of at least one kind of pyranose and furanose structures, the OH groups of the pyranose and furanose structures being partially esterified with an aromatic organic acid (wherein the ratio A/B of the esterified rate A of the OH groups in the sugar ester compound to the acylated rate B of the OH groups in the cellulose acylate is 0.55 to 0.95); and (Component 2) an aromatic ester oligomer.

These components will now be described in detail.

### <Cellulose Acylate>

The cellulose acylate film used in the present invention contains a cellulose acylate having a total degree of acyl substitution of 2.0 to 2.35.

Examples of the cellulose, a raw material of the cellulose acylate used in the present invention, include cotton linters and wood pulp (hardwood pulp and softwood pulp). Cellulose acylate prepared from any cellulose material can be used, and a mixture from different materials may also be used. These cellulose materials are described in detail in, for example, “Purasuchikku zairyo koza (Plastic materials) (17) Sen-iso kei jushi (cellulose-based resin)” written by Marusawa and Uda, Nikkan Kogyo Shimbun, Ltd. (published in 1970). The celluloses described in Journal of Technical Disclosure Kogi No. 2001-1745 (pp. 7-8), Japan Institute of Invention and Innovation can also be used. In the present invention, any cellulose acylate-laminated film can be used.

The cellulose acylate preferably used in the present invention will now be described in detail. A β-1,4 bonding glucose unit constituting cellulose has free hydroxy groups at positions 2, 3, and 6. Cellulose acylate is a polymer prepared by acylation of a part or all of these hydroxy groups with acyl groups. The degree of acyl substitution indicates the total rate of acylation of the hydroxy groups at positions 2, 3, and 6 (100% acylation at each position corresponds to a degree of substitution of 1) of cellulose.

The acyl groups contained in the cellulose acylate used in the present invention may be of one type or two or more different types.

The acyl group of the cellulose acylate in the present invention may be an aliphatic group or an aryl group. The cellulose acylate may be, for example, an alkylcarbonyl ester, an alkenylcarbonyl ester, an aromatic carbonyl ester, or an aromatic alkylcarbonyl ester of cellulose. These esters may further include substituents. Preferred examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, isobutanoyl, tert-butanoyl, cyclohexanecarbonyl, oleoyl, benzoyl, naphthylcarbonyl, and cinnamoyl groups. Among these groups, more preferred are acetyl, propionyl, butanoyl, dodecanoyl, octadecanoyl, tert-butanoyl, oleoyl, benzoyl, naphthylcarbonyl, and cinnamoyl groups; particularly preferred are acetyl, propionyl, and butanoyl groups (for acyl groups having 2 to 4 carbon atoms); and most preferred is an acetyl group (for cellulose acetate).

The film of the present invention contains a cellulose acylate having a total degree of substitution of 2.0 to 2.35. The cellulose acylate preferably has a total degree of acyl substitution of 2.1 to 2.3, more preferably 2.13 to 2.27. At total degree of substitution to 2.0 to 2.35, occurrence of unevenness due to water condensation can be prevented.

The degree of acyl substitution can be measured in accordance with the method described in ASTM-D817-96. Hydroxy groups are usually present on the unacylated sites.

In a preferred embodiment of the present invention, even if the cellulose acylate film contains a cellulose acylate having a low degree of acyl substitution, a reduced change in retardation under hygrothermal conditions and a reverse wavelength dispersion (a positive ΔRe value) can be simultaneously achieved. Such a cellulose acylation film containing a cellulose acylate having a low degree of acyl substitution can be produced.

These cellulose acylates can be synthesized by a known process, for example, described in Japanese Patent Laid-Open No. 10-45804.

If the acylating agent used in the acylation of cellulose is an acid anhydride or chloride, the organic solvent in the reaction system is, for example, an organic acid, such as acetic acid, or methylene chloride.

If the acylating agent is an acid anhydride, a protic catalyst, such as sulfuric acid, is preferably used. If the acylating agent is an acid chloride (e.g., CH₃CH₂COCl), a basic compound is used.

The most typical synthetic process of an ester of cellulose with mixed fatty acids on an industrial scale involves acylation of cellulose with mixed organic acid components containing fatty acids (such as acetic acid, propionic acid, and valeric acid) or their acid anhydrides corresponding to acetyl group and other acyl groups.

The cellulose acylate preferably has a number-average molecular weight (Mn) of 40000 to 200000, more preferably 100000 to 200000. The cellulose acylate used in the present invention preferably has a ratio Mw/Mn of 4.0 or less, more preferably 1.4 to 2.3.

In the present invention, the average molecular weight and the molecular weight distribution of, for example, cellulose acylate can be calculated from the number-average molecular weight (Mn) and the weight-average molecular weight (Mw) that are determined by gel permeation chromatography (GPC), and the ratio can be calculated by the method described in International Publication No. WO2008/126535.

The content of the cellulose acylate in the film of the present invention is preferably 85% by mass or more, more preferably more than 85% by mass, most preferably 86% by mass or more, of the total mass of the film. The content of the cellulose acylate in the film can be decreased with an increase in the total degree of substitution of the cellulose acylate and can be increased with a decrease in the total degree of substitution.

### <Component 1>

The cellulose acylate film of the present invention contains a sugar ester compound. The sugar ester compound has one to six pyranose and/or furanose structures, and the OH groups of the pyranose and/or furanose structures are partially esterified and the esterification is carried out with an aromatic organic acid.

The structural unit of the sugar ester compound includes a pyranose structural or furanose structural unit. A sugar ester composed of a polysaccharide may include both pyranose and furanose structural units. The sugar ester compound includes a structure (hereinafter, also referred to as sugar residue) derived from a monosaccharide or a polysaccharide constituting the sugar ester compound.

The sugar residue of the sugar ester compound may be derived from a pentose or a hexose.

The number of the structural units included in the sugar ester compound is one to six, preferably one or two.

Examples of the monosaccharide or the sugar including two to six monosaccharide units include erythrose, threose, ribose, arabinose, xylose, lyxose, allose, altrose, glucose, fructose, mannose, gulose, idose, galactose, talose, trehalose, isotrehalose, neotrehalose, trehalosamine, kojibiose, nigerose, maltose, maltitol, isomaltose, sophorose, laminaribiose, cellobiose, gentiobiose, lactose, lactosamine, lactitol, lactulose, melibiose, primeverose, rutinose, scillabiose, sucrose, sucralose, turanose, vicianose, cellotriose, chacotriose, gentianose, isomaltotriose, isopanose, maltotriose, manninotriose, melezitose, panose, planteose, raffinose, solatriose, umbelliferose, lycotetraose, maltotetraose, stachyose, baltopentaose, belbalcose, maltohexaose, α-cyclodextrin, β-cyclodextrin, γ-cyclodextrin, δ-cyclodextrin, xylitol, and sorbitol.

Preferred examples are ribose, arabinose, xylose, lyxose, glucose, fructose, mannose, galactose, trehalose, maltose, cellobiose, lactose, sucrose, sucralose, α-cyclodextrin, β-cyclodextrin, γ-cyclodextrin, δ-cyclodextrin, xylitol, and sorbitol; more preferred are arabinose, xylose, glucose, fructose, mannose, galactose, maltose, cellobiose, sucrose, β-cyclodextrin, and γ-cyclodextrin; more preferred are xylose, glucose, fructose, mannose, galactose, maltose, cellobiose, sucrose, xylitol, and sorbitol; and most preferred are glucose and fructose.

The OH groups in the pyranose structure and the furanose structure may be partially esterified with any aromatic organic acid and are preferably esterified with an aromatic monocarboxylic acid.

Examples of the aromatic monocarboxylic acid include aromatic monocarboxylic acids having alkyl or alkoxy groups on the benzene rings of benzoic acid compounds such as benzoic acid and toluic acid; cinnamic acid; aromatic monocarboxylic acids having two or more benzene rings, such as benzilic acid, biphenylcarboxylic acid, naphthalenecarboxylic acid, and tetralincarboxylic acid; and derivatives thereof. More specifically, the aromatic monocarboxylic acids are xylic acid, hemellitic acid, mesitylene acid, prehnitic acid, γ-isodurylic acid, durylic acid, mesitoic acid, α-isodurylic acid, cuminic acid, α-toluic acid, hydroatropic acid, atropic acid, hydrocinnamic acid, salicylic acid, o-anisic acid, m-anisic acid, p-anisic acid, creosotic acid, o-homosalicylic acid, m-homosalicylic acid, p-homosalicylic acid, o-pyrocatechuic acid, β-resorcylic acid, vanillic acid, isovanillic acid, veratric acid, o-veratric acid, gallic acid, asaronic acid, mandelic acid, homoanisic acid, homovanillic acid, homoveratric acid, o-homoveratric acid, phthalonic acid, and p-coumaric acid. In particular, benzoic acid is preferred. That is, R¹¹ and R¹² in the following formula (1A) preferably represent benzoyl groups.

### —Structure of Substituent—

The sugar ester compound including the substituents used in the present invention more preferably has a structure represented by Formula (1A):

(OH)ₚ-G-(L¹-R¹¹)_{q}(O—R¹²)ᵣ Formula (1A):

where G represents a sugar residue; L¹ represents —O—, —CO—, or —NR¹³—; R¹¹ represents a hydrogen atom or a monovalent aromatic group; R¹² represents a monovalent aromatic group bonded through an ester bond; and p, q, and r each independently represent an integer of 0 or more. The sum of p+q+r is equal to the number of hydroxy groups, given that G is an unsubstituted sugar having a cyclic acetal structure.

Preferred examples of the sugar residue represented by G are the same as those of the sugar residue described above.

L¹ preferably represents —O— or —CO— and more preferably —O—. If L¹ is —O—, the L¹ is preferably a linking group derived from an ether or ester bond and most preferably a linker derived from an ester bond.

If two or more L¹'s are present, they may be the same or different.

In particular, if L¹ is —O— (that is, hydroxy groups in the sugar ester compound are replaced with R¹¹ and R¹²), R¹³ is preferably selected from substituted or unsubstituted acyl groups, substituted or unsubstituted aryl groups, substituted or unsubstituted alkyl groups, and substituted or unsubstituted amino groups, more preferably selected from substituted or unsubstituted acyl groups, substituted or unsubstituted alkyl groups, and substituted or unsubstituted aryl groups, and most preferably selected from unsubstituted acyl groups, substituted or unsubstituted alkyl groups, and unsubstituted aryl groups.

R¹¹ and R¹² each independently represent a hydrogen atom or a monovalent aromatic group. Examples of the monovalent aromatic group include substituents prepared by esterification of the above-mentioned aromatic organic acids. In particular, a benzoyl group is preferred.

If there are pluralities of R¹¹, R¹², and R¹³, these may be the same or different.

The subscript p represents an integer of 0 or more. The preferred range of the integer is the same as the preferred range of the number of hydroxy groups per monosaccharide unit described below.

The subscript r preferably is a number larger than the number of the pyranose structural units or furanose structural units contained in G.

The subscript q is preferably zero.

Since the sum of p+q+r is equal to the number of hydroxy groups, given that G is an unsubstituted sugar having a cyclic acetal structure, the upper limits of p, q, and r are uniquely determined from the structure represented by G.

The number of hydroxy groups per structural unit (hereinafter, also referred to as hydroxy number) in the sugar ester compound is preferably 3 or less, more preferably 1 or less. A hydroxy number controlled within such a range can prevent the migration of the sugar ester compound to a polarizer layer over time under high-temperature and high-humidity environments and can prevent the decomposition of a PVA-iodine complex. The control of such a hydroxy number is preferred from the point of preventing the deterioration of the polarizer performance over time under high-temperature and high-humidity environments.

The sugar ester compound is commercially available from, for example, Tokyo Chemical Industry Co., Ltd. or Sigma-Aldrich Corporation or can be synthesized by any known esterification process of a commercially available carbohydrate (for example, the method described in Japanese Patent Laid-Open No. H08-245678).

The sugar ester compound preferably has a number-average molecular weight in a range of 200 to 3500, more preferably 200 to 3000, most preferably 250 to 2000.

Embodiments of the sugar ester compound that can be preferably used in the present invention will now be described, but should not be construed to limit the present invention. The degree of substitution is appropriately determined such that the ratio A/B is within the above-mentioned range.

### Sugar Ester

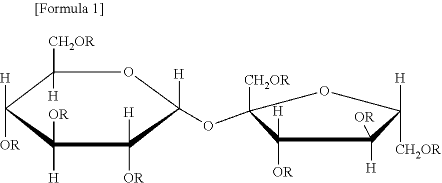

R's are replaced with, for example, benzoyl, benzyl, and phenylacetyl groups. The degree of substitution of R's is 3 to 6, more preferably 4 to 5.5; and the residual R's are hydrogen atoms.

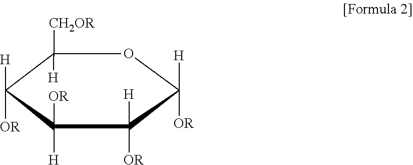

R's are replaced with, for example, benzoyl, benzyl, and phenylacetyl groups. The degree of substitution of R's is 2 to 4; and the residual R's are hydrogen atoms.

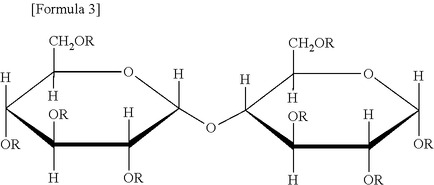

R's are replaced with, for example, benzoyl, benzyl, and phenylacetyl groups. The degree of substitution of R's is 3 to 6, more preferably 4 to 5.5; and the residual R's are hydrogen atoms.

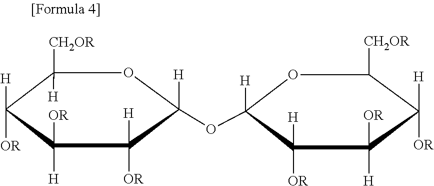

R's are replaced with, for example, benzoyl, benzyl, and phenylacetyl groups. The degree of substitution of R's is 3 to 6, more preferably 4 to 5.5; and the residual R's are hydrogen atoms.

The sugar ester compound is added in an amount of preferably 2 to 30 parts by mass, preferably 5 to 20 parts by mass, to 100 parts by mass of the cellulose acylate.

### <A/B>

In the present invention, the ratio A/B of the esterified rate A of the OH groups in the sugar ester compound to the acylated rate B of the OH groups in the cellulose acylate is 0.55 to 0.95, preferably 0.6 to 0.9, more preferably 0.7 to 0.8.

A sugar ester having a ratio A/B of 0.55 to 0.95 has high compatibility with a cellulose acylate having a degree of substitution of 2.0 to 2.35.

### <Component 2>

The cellulose acylate film of the present invention includes an aromatic ester oligomer. The aromatic ester oligomer can be prepared by, for example, a reaction of a mixture of aromatic dicarboxylic acids having 8 to 20 carbon atoms with a diol component. Both terminals of the reaction product may be untreated, or may be treated by a reaction with a monocarboxylic acid, alcohol, or phenol to block the terminals. In particular, when the blocking of the terminal is carried out with the object that the cellulose acylate film does not comprise free carboxylic acid terminals, it is effective for preservation stability.

Examples of the diol include aliphatic diols having 2 to 12 carbon atoms, alkyl ether diols having 4 to 20 carbon atoms, and aromatic diols having 6 to 20 carbon atoms. The aromatic ester oligomer preferably has a molecular weight of 300 to 5000, more preferably 350 to 4500, and most preferably 400 to 4000.

Examples of the aromatic dicarboxylic acids having 8 to 20 carbon atoms include phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid, and 2,6-naphthalenedicarboxylic acid. Among these aromatic dicarboxylic acids, preferred are phthalic acid, terephthalic acid, isophthalic acid, 1,5-naphthalenedicarboxylic acid, and 1,4-naphthalenedicarboxylic acid; and more preferred are phthalic acid, terephthalic acid, and isophthalic acid.

Examples of the aliphatic diols having 2 to 20 carbon atoms include alkyl diols and alicyclic diols, such as ethanediol, 1,2-propanediol (propylene glycol), 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, 1,4-cyclohexanediol, and 1,4-cyclohexanedimethanol. These glycols may be used alone or in a mixture.

Preferred aliphatic diols are ethanediol, 1,2-propanediol, 1,3-propanediol, 1,2-butanediol, 1,3-butanediol, 2-methyl-1,3-propanediol, 1,4-butanediol, 1,5-pentanediol, 3-methyl-1,5-pentanediol, 1,6-hexanediol, 1,4-cyclohexanediol, and 1,4-cyclohexanedimethanol; and particularly preferred are ethanediol, 1,2-propanediol, 1,3-propanediol, 1,2-butanediol, 1,3-butanediol, 1,4-butanediol, 1,5-pentanediol, 1,6-hexanediol, 1,4-cyclohexanediol, and 1,4-cyclohexanedimethanol.

Preferred examples of the alkyl ether diols having 4 to 20 carbon atoms include polytetramethylene ether glycol, polyethylene ether glycol, polypropylene ether glycol, and combinations thereof. These glycols may have any average degree of polymerization, which is preferably 2 to 20, more preferably 2 to 10, more preferably 2 to 5, most preferably to 4. Examples thereof include typically useful commercially available polyether glycols: Carbowax resins, Pluronics resins, and Niax resins.

Examples of the aromatic diols having 6 to 20 carbon atoms include, but not limited to, bisphenol A, 1,2-hydroxybenzene, 1,3-hydroxybenzene, 1,4-hydroxybenzene, and 1,4-benzenedimethanol. Among them, preferred are bisphenol A, 1,4-hydroxybenzene, and 1,4-benzenemethanol.

In the present invention, particularly preferred are high-molecular-weight additives of which terminals are blocked with alkyl or aromatic groups. The terminals protected with such hydrophobic functional groups are resistant to degradation over time under high-temperature and high-humidity environments and delay the hydrolysis of ester groups.

In the present invention, the terminals of a polyester additive are preferably protected with monoalcohol or monocarboxylic acid residues such that both terminals are not carboxylic acids or OH groups.

The monoalcohol in this case is preferably a substituted or unsubstituted monoalcohol having 1 to 30 carbon atoms. Examples of such monoalcohols include aliphatic alcohols, such as methanol, ethanol, propanol, isopropyl alcohol, butanol, isobutyl alcohol, pentanol, isopenty alcohol, hexanol, isohexyl alcohol, cyclohexyl alcohol, octanol, isooctyl alcohol, 2-ethylhexyl alcohol, nonyl alcohol, isononyl alcohol, tert-nonyl alcohol, decanol, dodecanol, dodecahexanol, dodecaoctanol, allyl alcohol, and oleyl alcohol; and substituted alcohols, such as benzyl alcohol and 3-phenylpropanol.

Alcohols for terminal blocking that can be preferably used are methanol, ethanol, propanol, isopropyl alcohol, butanol, isobutyl alcohol, isopenty alcohol, hexanol, isohexyl alcohol, cyclohexyl alcohol, isooctyl alcohol, 2-ethylhexyl alcohol, isononyl alcohol, oleyl alcohol, and benzyl alcohol; and particularly preferred are methanol, ethanol, propanol, isobutyl alcohol, cyclohexyl alcohol, 2-ethylhexyl alcohol, isononyl alcohol, and benzyl alcohol.

If the terminals of the polyester additive are blocked with monocarboxylic acid residues, substituted or unsubstituted monocarboxylic acids having 1 to 30 carbon atoms are preferably used as the monocarboxylic acid residues. These monocarboxylic acids may be aliphatic monocarboxylic acids or aromatic ring-containing carboxylic acids. Preferred examples of the aliphatic monocarboxylic acid include acetic acid, propionic acid, butanoic acid, caprylic acid, caproic acid, decanoic acid, dodecanoic acid, stearic acid, and oleic acid; and preferred examples of the aromatic ring-containing monocarboxylic acid include benzoic acid, p-tert-butylbenzoic acid, p-tert-amylbenzoic acid, normal-propylbenzoic acid, aminobenzoic acid, and acetoxybenzoic acid. These monocarboxylic acids may be used alone or in combination.

The high-molecular-weight additives according to the present invention can be readily synthesized by a common process, i.e., by hot melt condensation through polyesterification or transesterification of the above-mentioned dicarboxylic acid with a diol and/or a monocarboxylic acid for terminal blocking or a monoalcohol or by interfacial condensation of an acid chloride and a glycol. These polyester additives are described in detail in “Tenkazai Sono Riron to Oyo (Additives, Its Theory and Application)”, Edited by Koichi Murai, (Saiwai Shobo Co., Ltd., First edition, Mar. 1, 1973). The materials described in Japanese Patent Laid-Open Nos. H05-155809, H05-155810, H05-197073, 2006-259494, H07-330670, and 2007-003679 can be also used.

The compounds described in International Publication No. WO2011/148869 can be also preferably used.

In the present invention, a particularly preferred ester oligomer is a reaction product of propylene glycol and terephthalic acid (TPA), the product having methyl benzoate (mBA) or benzoate (BA) terminals.

The aromatic ester oligomer is added in an amount of preferably 0.5 to 10 parts by mass, more preferably 1 to 5 parts by mass, to 100 parts by mass of the cellulose acylate.

### <Other Additives>

### (1) Discotic Compound

The film of the present invention preferably contains at least one discotic compound.

The discotic compound includes a mother nucleus of pyridine, pyrimidine, triazine, or purine and has a substituent at any substitutable position on the mother nucleus, the substituent being an alkyl group, an alkenyl group, an alkynyl group, an amino group, an amido group (a structure having an acyl group through an amido bond), an aryl group, an alkoxy group, a thioalkoxy group, an alkyl or aryl thio group (a group linking an alkyl group or an aryl group via a sulfur atom), or a heterocyclic group. The substituent at the mother nucleus of the discotic compound may also have any substituent. For example, for a mother nucleus having an amino substituent group, the amino group may have one or more substituents such as alkyl group(s) (where two alkyls may optionally be linked to each other to form a ring) or —SO₂R′ (R′ represents a substituent).

The amount of the discotic compound in the film of the present invention is preferably less than 7% by mass, more preferably 1% to 5% by mass, most preferably 1% to 3% by mass, of the amount of the cellulose acylate.

In the film of the present invention, the discotic compound may be a known retardation-expressing agent. The use of a retardation-expressing agent provides high retardation characteristics at a low stretching rate. The film of the present invention produced through the process, described below, of producing the cellulose acylate film, however, has satisfactory retardation characteristics, even if the film does not contain the retardation-expressing agent.

The retardation-expressing agent is particularly not limited, but is preferably a rod-shaped compound, a compound having a cyclic structure, such as a cycloalkane or aromatic ring, or a non-phosphate ester compound having retardation characteristics. The compound having a cyclic structure is preferably a discotic compound. The rod-shaped or discotic compound serving as a retardation-expressing agent is preferably a compound having at least two aromatic rings.

Two or more retardation-expressing agents may be used in combination.

The retardation-expressing agent preferably substantially does not absorb light in the visible region.

Examples of the retardation-expressing agent include, but not limited to, the compounds described in Japanese Patent Laid-Open Nos. 2004-50516, 2007-86748, and 2010-46834.

Preferred examples of the discotic compound also include compounds described in European Patent Publication No. 0911656 A2, triazine compounds described in Japanese Patent Laid-Open No. 2003-344655, and triphenylene compounds described in paragraphs [0097] to [0108] of Japanese Patent Laid-Open No. 2008-150592.

In addition, compounds described in paragraphs [0062] to [0081] of Japanese Patent Laid-Open No. 2012-144627 can be preferably used.

The discotic compound can be synthesized by a known process, for example, described in Japanese Patent Laid-Open Nos. 2003-344655 and 2005-134884.

In addition to the above-mentioned discotic compounds, rod-shaped compounds having linear molecular structures can also be preferably used. Such rod-shaped compounds are described, for example, in paragraphs [0110] to [0127] of Japanese Patent Laid-Open No. 2008-150592.

Examples of the discotic compound in the present invention include, but not limited to, the following compounds:

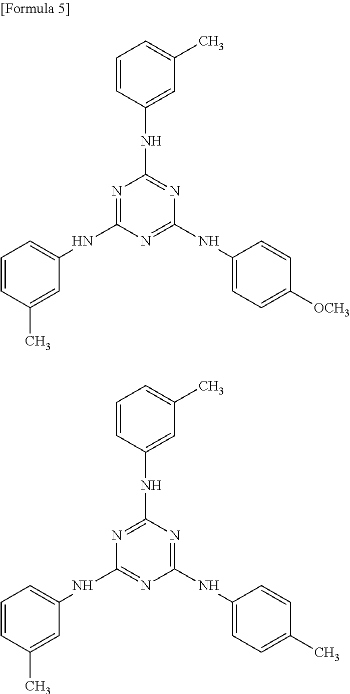 [SMILES: COc1ccc(Nc2nc(Nc3cccc(C)c3)nc(Nc3cccc(C)c3)n2)cc1 ; Cc1ccc(Nc2nc(Nc3cccc(C)c3)nc(Nc3cccc(C)c3)n2)cc1]

The cellulose acylate film used in the present invention can further contain additives that can be compounded in usual cellulose acylate films.

Examples of the additives include additives having negative intrinsic birefringences, fine particles, retardation-expressing agents, antioxidants, thermal degradation inhibitors, coloring agents, and ultraviolet absorbers.

In addition, the compounds described in International Publication No. WO2008/126535 can be preferably used as the additives.

### (2) Additive Having Negative Intrinsic Birefringence

The film of the present invention may contain an additive having a negative intrinsic birefringence. Compounds having negative intrinsic birefringences that can be used as additives will now be described.

The compound having a negative intrinsic birefringence is a material showing a negative intrinsic birefringence in a specific direction in a cellulose acylate film. Throughout the specification, the term “negative intrinsic birefringence” refers to negative birefringent characteristics. The negative intrinsic birefringence of the compound can be determined, for example, by measuring the birefringence of a film containing the compound and the birefringence of a film not containing the compound with a birefringence meter and comparing the difference in the birefringence therebetween.

The compound having a negative intrinsic birefringence of the present invention may be any known compound having a negative intrinsic birefringence. Preferred examples of such compounds are those described in paragraphs [0036] to [0092] of Japanese Patent Laid-Open No. 2010-46834.

Examples of the compound having a negative intrinsic birefringence include polymers having negative intrinsic birefringences and acicular nanoparticles having negative intrinsic birefringences (including acicular nanoparticles of polymers having negative intrinsic birefringences). A polymer having a negative intrinsic birefringence that can be used in the present invention will now be described.

When light is incident on a layer of uniaxially aligned molecules in the polymer having a negative intrinsic birefringence, the polymer has a refractive index of the light in the alignment direction smaller than that of the light in the direction orthogonal to the alignment direction.

Examples of the polymer having a negative intrinsic birefringence include polymers having specific cyclic structures (discotic rings such as aliphatic-aromatic rings and heteroaromatic rings) at side chains (e.g., styrene polymers, such as polystyrene, poly(4-hydroxy)styrene, and styrene-maleic anhydride copolymers, and polyvinylpyridine); (meth)acrylic polymers, such as poly(methyl methacrylate); and cellulose ester polymers (excluding those having positive birefringence), polyester polymers (excluding those having positive birefringence), acrylonitrile polymers, alkoxysillyl polymers, and their polydimensional (e.g., two-dimensional or three-dimensional) copolymerized polymers. These polymers may be used alone or in combination. The copolymer may be a block copolymer or a random copolymer.

Among these polymers, more preferred are polymers having specific cyclic structures, such as (meth)acrylic polymers, and alkoxysillyl polymers, and most preferred are polystyrene, polyhydroxystyrene, polyvinylpyridine, and (meth)acrylic polymers.

The cellulose acylate film containing the polymer having a specific cyclic structure can have a high Rth value and is thus preferred.

The polymers having aliphatic-aromatic rings at the side chains described in Japanese Patent Laid-Open No. 2010-46834 can be preferably used as the polymer having a specific cyclic structure. Among the polymers, preferred are polystyrene and poly(4-hydroxy)styrene; and more preferred are copolymers of polystyrene and poly(4-hydroxy)styrene. The monomer ratio (molar ratio) of polystyrene to poly(4-hydroxy)styrene in the copolymer is preferably 10/90 to 100/0, more preferably 20/80 to 90/10.

Other preferred examples of the polymer having a specific cyclic structure are polymers having heteroaromatic rings at the side chains, such as polyvinylpyridine.

The cellulose acylate film containing the (meth)acrylic polymer can have high transparency and significantly low water vapor transmission and shows excellent performance as a protective film for a polarizing plate. Preferred (meth)acrylic polymers are compounds described in Japanese Patent Laid-Open No. 2009-1696 and International Publication No. WO2008-126535. The (meth)acrylic polymer may have an aliphatic-aromatic ring or a heteroaromatic ring at the side chain.

When the compound having a negative intrinsic birefringence is a polymer having a negative intrinsic birefringence, the weight-average molecular weight is preferably 500 to 100000, more preferably 700 to 50000, most preferably 700 to 10000.

In a preferred embodiment, a molecular weight of 500 or more can provide satisfactory volatility, and a molecular weight of 100000 or less can provide satisfactory compatibility with a cellulose acylate resin, resulting in satisfactory formation of a cellulose acylate film.

In the film of the present invention, the amount of the compound having a negative intrinsic birefringence is preferably 0% to 20% by mass, more preferably 0% to 15% by mass, most preferably 0% to 10% by mass, of the amount of the cellulose acylate.

The film of the present invention can have high reverse wavelength dispersion by being produced through the process, described below, of producing the cellulose acylate film, even if the film does not contain a relatively expensive compound having a negative intrinsic birefringence. Accordingly, the film of the present invention containing a less amount of the compound having a negative intrinsic birefringence is preferred from the viewpoint of reducing the manufacturing cost.

### (3) Nanoparticles

Examples of the nanoparticles that can be used in the present invention include inorganic compounds, such as silicon dioxide, titanium dioxide, aluminum oxide, zirconium oxide, calcium carbonate, talc, clay, baked kaolin, baked calcium silicate, calcium silicate hydrate, aluminum silicate, magnesium silicate, and calcium phosphate.

Silicon-containing nanoparticles, which can reduce the haze, are preferred. In particular, silicon dioxide is preferred.

The primary particles of the nanoparticles preferably have an average particle diameter of 5 to 50 nm, more preferably 7 to 20 nm. Preferably, these particles are contained mainly in the form of aggregates having diameters ranging from 0.05 to 0.3 μm.

Usable nanoparticles of silicon dioxide are commercially available, for example, under a trade name of Aerosil series R972, R972V, R974, R812, 200, 200V, 300, R202, OX50, TT600, and NAX50 (manufactured by Nippon Aerosil Co., Ltd.).

Usable nanoparticles of zirconium oxide are commercially available, for example, under the trade name of Aerosil R976 and Aerosil R811 (manufactured by Nippon Aerosil Co., Ltd.).

Examples of the polymer include silicone resins, fluorine resins, and acrylic resins. Preferred are silicone resins, in particular, silicone resins having three-dimensional network structures. Usable silicon resins are commercially available, for example, under the trade name of Tospearl series 103, 105, 108, 120, 145, 3120, and 240 (manufactured by Toshiba Silicones Co., Ltd.).

Among these nanoparticles, particularly preferred are Aerosil 200V and Aerosil R972V that notably reduce the coefficient of friction while maintaining low haze of a cellulose derivative film.

The content of the nanoparticles is preferably 0.05% to 1% by mass, most preferably 0.1% to 0.5% by mass, based on the amount of the cellulose acylate in the cellulose film of the present invention. A cellulose derivative film having a multilayer structure produced by co-casting preferably contains the nanoparticles in the surface layer within the amount mentioned above.

### (4) Antioxidant and Thermal Degradation Inhibitor

Any known antioxidant and thermal degradation inhibitor can be used in the present invention. Preferred examples of such a compound include lactones, sulfur-based compounds, phenols, double bond compounds, hindered amines, and phosphorus compounds. Preferred antioxidants and thermal degradation inhibitors are described in International Publication No. WO2008-126535.

### (5) Coloring Agent

In the present invention, a coloring agent can also be used. In a general sense, the term “coloring agent” refers to a dye or a pigment, while in the present invention, the term “coloring agent” refers to a material controlling a liquid crystal screen to a blue color tone or a material controlling the yellow index or reducing the haze. Preferred coloring agents are described in International Publication No. WO2008-126535.

### (6) Stripping Enhancer

In the present invention, a stripping enhancer may be used. Preferred stripping enhancers are described in paragraphs [0030] to [0041] of Japanese Patent Laid-Open No. 2011-183759.

### (Layer Structure of Cellulose Acylate Film)

Although the film of the present invention may have a monolayer structure or a multilayer structure of two or more layers, preferred has a monolayer structure.

### (Thickness of Film)

The film of the present invention has a thickness of to 39 μm. Such a thin cellulose acylate film can provide a thin polarizing plate and a thin liquid crystal display. The thickness of the film of the present invention is preferably 25 to 35 μm. When the film of the present invention has a multilayer structure, the film preferably has a total thickness within the above-mentioned range.

### (Width of Film)

The film of the present invention preferably has a width of 1000 mm or more, more preferably 1500 mm or more, most preferably 1800 mm or more.

(ΔRth Value Between Before and after Water Contact Test)

The cellulose acylate film of the present invention has an absolute ΔRth value between before and after the following water contact test of preferably 5 nm or less, more preferably 3 nm or less, most preferably 0 to 3 nm.

### (Water Contact Test)

A film is immersed in water at 40° C. for 12 hours. After the waterdrops on the surfaces of the film is wiped off, the film is dried in air. Subsequently, the film is left to stand at 25° C. and 60% RH for 24 hours. The Re and Rth values are measured at a wavelength of 590 nm with KOBRA 21ADH (manufactured by Oji Scientific Instruments) by the process described above. The Rth value of an untreated film is also measured to determine the difference ΔRth between Rth before treatment and Rth after treatment.

### (Re and Rth)

The film of the present invention preferably satisfies Formulae (1) and (2) defining the in-plane retardation and the thickness-direction retardation at a wavelength of 550 nm:

40 nm≦Re(550)≦80 nm Formula (1):

where, Re(550) represents in-plane retardation at a wavelength of 550 nm,

100 nm≦Rth(550)≦300 nm Formula (2):

where, Rth(550) represents thickness-direction retardation at a wavelength of 550 nm.

The Formula of the retardation in such a range is preferred from the viewpoint of improving the contrast and reducing the change in black tone of a liquid crystal display.

The Re(550) value is preferably 40 to 65 nm, more preferably 45 to 60 nm.

The Rth(550) is preferably 90 to 300 nm, more preferably 100 to 230 nm.

The film of the present invention is preferably a biaxial optical compensation film.

In the biaxial optical compensation film, the nx, ny, and nz (nx represents a refractive index in the in-plane slow axis direction; ny represents a refractive index in the in-plane direction perpendicular to nx; and nz represents a refractive index in the direction perpendicular to nx and ny) are different from one another and preferably satisfy the relationship: nx>ny>nz.

The film of the present invention showing biaxial optical characteristics is preferred for reducing the problem of color shift when a liquid crystal display, in particular, a VA mode liquid crystal display is viewed from an oblique direction.

Throughout the specification, the Re(λ) and the Rth(λ) represent the in-plane retardation and the thickness-direction retardation, respectively, at a wavelength λ. Throughout the specification, the wavelength λ is 550 nm, unless otherwise specified. The Re(λ) value is measured with KOBRA 21ADH (manufactured by Oji Scientific Instruments) by allowing light having a wavelength λ nm to enter a film from the normal direction of the film. The Rth(λ) value is calculated as follows: The Re(λ) values of light having a wavelength λ nm entering a film from inclined six directions from the normal direction of the film up to 50° at every 10° are measured where the tilted axis (rotation axis) is the in-plane slow axis (determined with KOBRA 21ADH) (if there is no slow axis, the rotation axis is any in-plane direction of the film); and the Rth(λ) value is calculated based on the measured retardation values, the hypothetical mean refractive index, and the thickness of the film with KOBRA 21ADH. Alternatively, the Rth(λ) value can also be calculated on the basis of the retardation values measured from any two directions where the tilted axis (rotation axis) is the slow axis (if there is no slow axis, the rotation axis is any in-plane direction of the film), the hypothetical mean refractive index, and the thickness of the film, in accordance with Formulae (A) and (B). The hypothetical mean refractive index can be the value shown in Polymer Handbook (JOHN WILEY & SONS, INC.) or catalogues of relevant optical films. If the mean refractive index is not known, the value can be measured with an Abbe's refractometer. The mean refractive indices of major optical films are as follows: cellulose acylate (1.48), cycloolefin polymer (1.52), polycarbonate (1.59), poly(methyl methacrylate) (1.49), and polystyrene (1.59). The values nx, ny, and nz are calculated by inputting such a hypothetical mean refractive index and the film thickness into KOBRA 21ADH. Based on the calculated nx, ny, and nz, the value Nz (=(nx−nz)/(nx−ny)) is calculated.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad [ mathematical formula 1 ]$$

The Re(θ) represents the retardation value in the direction inclined by an angle θ from the normal line direction; nx, ny, and nz represent the respective refractive indices of the major axis azimuths in a refractive index ellipsoid; and d represents the thickness of the film.

Rth=((nx+ny)/2−nz)×d Formula (B):

In the calculation, the mean refractive index n is a necessary parameter. The index is measured with an Abbe's refractometer (“Abbe's refractometer 2-T”, manufactured by Atago Co., Ltd.).

### (Internal Haze)

The cellulose acylate film of the present invention preferably has an internal haze of less than 0.08%.

The haze value (%) is measured in accordance with JIS K7136.

The internal haze of the film of the present invention is determined as follows: Several drops of glycerin are placed on both surfaces of the resulting cellulose acylate film. The film is disposed between two glass plates with a thickness of 1.3 mm (MICRO SLIDE GLASS item No. 59213, manufactured by Matsunami Glass Ind., Ltd.), and the total haze (%) of the film and glycerin is measured in this state. Separately, several drops of glycerin are disposed between two glass plates, and the reference haze (%) of the glycerin is measured in this state. The internal haze of the film is calculated by subtracting the reference haze (%) of the glycerin from the total haze (%) of the film and glycerin.

The cellulose acylate film of the present invention is left to stand at 23° C. under a relative humidity of 55% for 24 hours, and the haze of the film is then measured with a turbidimeter (NDH2000, Nippon Denshoku Industries Co., Ltd.) in the same environment.

The cellulose acylate film of the present invention preferably has an internal haze of 0.05% or less, more preferably 0.03% or less.

Although lower haze is preferred, a merely low total haze is insufficient for improving the front contrast, and the adjustment of the internal haze in the above-mentioned range is preferred from the viewpoint of improving the front contrast of a liquid crystal display.

### (Rate of Change in Size)

The film of the present invention more preferably satisfies Formula (7) for the rates of change in size in the film-transporting direction and the direction orthogonal to the film-transporting direction after the film is left for 24 hours at 60° C. and 90% RH,

−0.5%≦{(L′−L0)/L0}×100≦0.5% (7)

where L0 represents the length of the film after humidification in an atmosphere of 25° C. and 60% RH for 2 hours or more, and L′ represents the length of the film after humidification in an atmosphere of 60° C. and 90% RH for 24 hours and further in an atmosphere of 25° C. and 60% RH for 2 hours.

A rate of change in size within the range shown by Formula (7) barely causes a dimensional change in the film during alkali saponification treatment and can prevent wrinkling and inclusion of air during the process of bonding the polarizing plate. The rate of change in size is preferably −0.4% to 0.4%, more preferably −0.2% to 0.2%.

### <Method of Producing Cellulose Acylate Film>

The cellulose acylate film that can be used in the present invention is described in paragraphs [0125] to [0177] of Japanese Patent Laid-Open No. 2012-068611, the content of which is incorporated by reference into the present specification, provided that the stretching temperature is at least Tg-30° C. or higher in the present invention.

### <Polarizing Plate>

The cellulose acylate film of the present invention serves as a retardation film and is preferably incorporated as a protective film into a polarizing plate.

That is, the polarizing plate of the present invention at least includes a polarizer and at least one cellulose acylate film of the present invention disposed on one side of the polarizer. The polarizing plate of the present invention will now be described.

Like the film of the present invention, embodiments of the polarizing plate of the invention include not only polarizing plates cut into film pieces having sizes allowing direct incorporation into liquid crystal displays but also long polarizing plates continuously produced and wound into a rolled state (e.g., a roll length of 2500 m or more or 3900 m or more). In order to be used in a large-screen liquid crystal display, the width of the polarizing plate is preferably 1470 mm or more as described above.

The polarizing plate of the present invention includes a polarizer preferably having a thickness of 3 to 20 μm, more preferably 5 to 20 μm.

The polarizing plate of the present invention includes a cellulose acylate film of the present invention on at least one side of the protective films of the polarizing plate. On the other side of the protective films of the polarizing plate, a known cellulose acylate film may be used. The protective film of the polarizing plate of a known cellulose acylate film preferably has a thickness of 10 to 40 μm, more preferably 20 to 40 μm.

The total thickness of the polarizing plate of the present invention is preferably 40 to 100 μm, more preferably 50 to 100 μm, most preferably 65 to 95 μm. The total thickness herein is the sum of the thicknesses of a polarizer, protective films of the polarizing plate disposed on both sides of the polarizer, and adhesive layers for bonding the protective films of the polarizing plate.

Specifically, the polarizing plate of the present invention may have any known structure, such as that shown in FIG. 6 of Japanese Patent Laid-Open No. 2008-262161.

### <Liquid Crystal Display>

The liquid crystal display of the present invention includes at least one polarizing plate of the present invention. The liquid crystal display of the present invention including the polarizing plate, which includes the cellulose acylate film of the present invention, exhibits significantly high contrast in the front direction and significantly low tonal change in the viewing angle direction.

In the liquid crystal display of the present invention, the glass of the liquid crystal cell preferably has a thickness of 50 to 500 μm. Such glass contributes to a reduction in thickness of the liquid crystal display.

The liquid crystal display of the present invention includes a liquid crystal cell and a pair of polarizing plates (at least one polarizing plate is that according to the present invention) disposed on both sides of the liquid crystal cell and is preferably of an IPS, OCB, or VA mode.

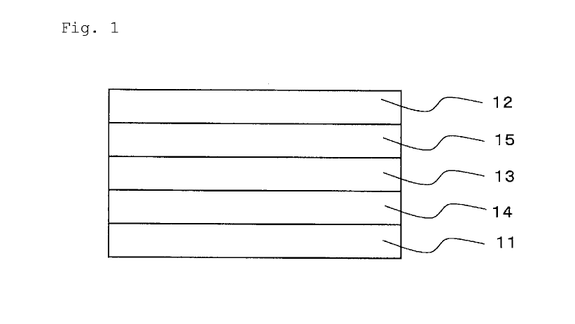

Specifically, the liquid crystal display of the present invention may have any known structure, such as the structure shown in FIG. 1 attached to the present specification or the structure shown in FIG. 2 of Japanese Patent Laid-Open No. 2008-262161.

### Examples

The present invention will now be described in more detail by ways of examples. The materials, amounts, ratios or proportions, details and orders of processes, and other factors in the following examples may be appropriately modified without departing from the gist of the present invention; hence, the following examples should not be construed to limit the scope of the present invention.

### <Process of Measurement>

In the present invention, the properties of films were measured by the following processes.

### (Optical Characteristics)

The Re and Rth values were measured at a wavelength of 590 nm with KOBRA 21ADH (manufactured by Oji Scientific Instruments) by the process described above. The unit was nm.

### (Water Contract Test)

A first protective film of the polarizing plate was immersed in water at 40° C. for 12 hours. After the waterdrops on the surfaces of the film was wiped off, the film was dried in air. Subsequently, the film was left to stand at 25° C. and 60% RH for 24 hours. The Re and Rth values were measured at a wavelength of 590 nm with KOBRA 21ADH (manufactured by Oji Scientific Instruments) by the process described above. The Rth value of an untreated film was also measured to determine the difference ΔRth between Rth before treatment and Rth after treatment.

### Examples and Comparative Examples

### (1) Synthesis of Cellulose Acylate Resin

Cellulose acylates having different degrees of acyl substitution shown in the following table were prepared. Catalytic sulfuric acid (7.8 parts by mass based on 100 parts by mass of cellulose) and each carboxylic acid were added to cellulose, followed by acylation at 40° C. The degree of substitution was then adjusted by controlling the amounts of the sulfuric acid catalyst and water and the aging time. The aging temperature was 40° C. Low-molecular-weight cellulose acylate components were then cleaned off with acetone.

### (2) Preparation of Dope

The composition shown below was placed in a mixing tank and was stirred to dissolve the individual components. The solution was then heated at 90° C. for about 10 minutes and was filtered through a filter paper having an average pore size of 34 μm and a sintered metal filter having an average pore size of 10 μm.

### Cellulose Acylate Solution

Cellulose acylate having a degree of acyl substitution shown in the following table: 100.0 parts by mass in total Sugar ester compound shown in the following table: (in an amount shown in the table, unit: part(s) by mass) Ester oligomer shown in the following table: (in an amount shown in the table, unit: part(s) by mass)
Aromatic discotic compound shown in the following table: (in an amount shown in the table, unit: part(s) by mass)
Stripping enhancer shown in the following table: (in an amount shown in the table, unit: part(s) by mass) Methylene chloride: 403.0 parts by mass Methanol: 60.2 parts by mass

Preparation of Matting Agent Dispersion

The following composition containing the cellulose acylate solution prepared above was placed in a disperser to prepare a matting agent dispersion.

### Matting Agent Dispersion

Matting agent (Aerosil R972): 0.2 parts by mass
Methylene chloride: 72.4 parts by mass
Methanol: 10.8 parts by mass
Cellulose acylate solution: 10.3 parts by mass

A dope for forming a film was prepared by mixing the matting agent dispersion with 100 parts by mass of the cellulose acylate solution such that the amount of the inorganic nanoparticles was 0.02 parts by mass of the amount of the cellulose acylate resin.

### (3) Casting

The above-described dope was cast with a band casting machine. The band was made of stainless steel.

### (4) Drying

The web (film) prepared by casting was peeled from the band and was dried for 20 minutes in a tenter system that clips both ends of the web to transports the web. The drying temperature was a film surface temperature of 100° C.

### (5) Stretching

The resulting web (film) was peeled from the band and was clipped. The film was stretched in the direction (transverse direction) orthogonal to the film-transporting direction at a stretching temperature of 175° C. and a stretching ratio of 1.35 with a tenter at an amount of residual solvent of 0% to 30% of the total mass of the film by fixed end uniaxial stretching. The thickness of the casting film was controlled such that the thickness (unit: μm) of the stretched film was as shown in the table.

### (6) Hygrothermal Treatment

Each stretched film was sequentially subjected to treatment for dew condensation prevention, hygrothermal treatment (steam contact treatment), and heat treatment.

In the treatment for dew condensation prevention, each film was exposed to dry air to adjust the film temperature Tf0 to 120° C. In the hygrothermal treatment (steam contact treatment), each film was transported while the film temperature (hygrothermal treatment temperature) being maintained at 100° C. for a treatment time (60 sec), where the absolute humidity (absolute humidity for hygrothermal treatment) of the wet gas in the wet gas contact chamber was controlled to 400 g/m³, and the dew point of the wet gas was controlled to a temperature at least 10° C. higher than the film temperature Tf0.

### (7) Drying and (8) Heat Treatment after Hygrothermal Treatment

In the heat treatment, the absolute humidity (heat treatment absolute temperature) of the gas in the heat treatment chamber was adjusted to 0 g/m³, and the temperature (heat treating temperature) of each film was adjusted for a treatment time (2 min) to the same temperature as the temperature of the hygrothermal treatment. The film surface temperature was the average of the temperatures at three points of a film measured with a tape-type thermocouple surface temperature sensor (ST series manufactured by Anritsu Meter Co., Ltd.).

### (9) Winding

Each film was cooled to room temperature and was then wound. At least 24 rolls each having a width of 1280 mm and a length of 2600 mm were produced under the above-described conditions for evaluation of the productability. Samples (width: 1280 mm) having a length of 1 m were cut in the longitudinal direction from one roll of the continuously produced 24 rolls per 100 meters of the roll. These samples were used as films of Examples and Comparative Examples in each measurement.

TABLE 1

| | Cellulose acylate | | | | | | | |
|---|---|---|---|---|---|---|---|---|
| | degree of | | | | | | | |
| | acyl | | Sugar ester compound | | | | Ester oligomer | |
| | substitution | B (%) | Kind | A (%) | Amount | A/B | Kind | Amount |
| Example 1 | 2.15 | 72% | SucBA4 | 50% | 10% | 0.70 | mBA/PG/TPA/PG/mBA | 3 |
| Example 2 | 2.15 | 72% | SucBA4.5 | 56% | 10% | 0.78 | mBA/PG/TPA/PG/mBA | 3 |
| Example 3 | 2.15 | 72% | SucBA4.5 | 56% | 10% | 0.78 | BA/PG/TPA/PG/BA | 3 |
| Example 4 | 2.15 | 72% | SucBA5 | 63% | 10% | 0.87 | mBA/PG/TPA/PG/mBA | 3 |
| Example 5 | 2.15 | 72% | SucBA4 | 50% | 10% | 0.70 | mBA/PG/TPA/PG/mBA | 3 |
| Example 6 | 2.15 | 72% | SucBA4.5 | 56% | 10% | 0.78 | mBA/PG/TPA/PG/mBA | 3 |
| Example 7 | 2.15 | 72% | SucBA4.5 | 56% | 10% | 0.78 | BA/PG/TPA/PG/BA | 3 |
| Example 8 | 2.15 | 72% | SucBA5 | 63% | 10% | 0.87 | mBA/PG/TPA/PG/mBA | 3 |
| Example 9 | 2.15 | 72% | SucBA4.5 | 56% | 10% | 0.78 | mBA/PG/TPA/PG/mBA | 3 |
| Example 10 | 2.15 | 72% | SucBA4.5 | 56% | 10% | 0.78 | mBA/PG/TPA/PG/mBA | 3 |
| Example 11 | 2.15 | 72% | SucBA4.5 | 56% | 10% | 0.78 | mBA/PG/TPA/PG/mBA | 3 |
| Example 12 | 2.22 | 74% | SucBA4 | 56% | 10% | 0.76 | mBA/PG/TPA/PG/mBA | 3 |
| Example 13 | 2.29 | 76% | SucBA5 | 63% | 10% | 0.83 | mBA/PG/TPA/PG/mBA | 3 |
| Example 14 | 2.15 | 72% | SucBA4 | 50% | 10% | 0.70 | mBA/PG/TPA/PG/mBA | 3 |
| Comp. Exam. 1 | 2.15 | 72% | SucBA3 | 38% | 10% | 0.52 | mBA/PG/TPA/PG/mBA | 3 |
| Comp. Exam. 2 | 2.15 | 72% | SucBA5.5 | 69% | 10% | 0.96 | mBA/PG/TPA/PG/mBA | 3 |
| Comp. Exam. 3 | 2.15 | 72% | SucAc4 | 50% | 10% | 0.70 | mBA/PG/TPA/PG/mBA | 3 |
| Comp. Exam. 4 | 2.15 | 72% | SucBA4.5 | 56% | 10% | 0.78 | Aliphatic ester oligomer | 3 |
| Comp. Exam. 5 | 2.15 | 72% | be not added | | | 0.00 | mBA/PG/TPA/PG/mBA | 3 |
| Comp. Exam. 6 | 1.9 | 63% | SucBA4 | 50% | 10% | 0.79 | mBA/PG/TPA/PG/mBA | 3 |
| Comp. Exam. 7 | 2.45 | 82% | SucBA4.5 | 56% | 10% | 0.69 | mBA/PG/TPA/PG/mBA | 3 |
| Comp. Exam. 8 | 2.15 | 72% | SucBA4.5 | 56% | 10% | 0.78 | be not added | 0 |
| Comp. Exam. 9 | 2.15 | 72% | SucBA4.5 | 56% | 10% | 0.78 | Aliphatic ester oligomer | 3 |
| Comp. Exam. 10 | 2.45 | 82% | SucBA4.5 | 56% | 10% | 0.69 | mBA/PG/TPA/PG/mBA | 3 |

| | | | | | | | | Total |
|---|---|---|---|---|---|---|---|---|
| | | | | | Thickness of | Thickness | Thickness | thickness |
| | | | Stripping | | First | of | of Second | of |
| | Discotic compound | | enhancer | | protective film | polarizer | protective | polarizing |
| | Kind | Amount | Kind | Amount | (μm) | (μm) | film (μm) | plate (μm) |
| Example 1 | | 0 | KV37 | 1 | 35 | 20 | 40 | 95.4 |
| Example 2 | | 0 | KV37 | 1 | 35 | 20 | 40 | 95.4 |
| Example 3 | | 0 | KV37 | 1 | 35 | 20 | 40 | 95.4 |
| Example 4 | | 0 | KV37 | 1 | 35 | 20 | 40 | 95.4 |
| Example 5 | Compound 1 | 2 | KV37 | 1 | 25 | 20 | 40 | 85.4 |
| Example 6 | Compound 1 | 2 | KV37 | 1 | 25 | 20 | 40 | 85.4 |
| Example 7 | Compound 1 | 2 | KV37 | 1 | 25 | 20 | 40 | 85.4 |
| Example 8 | Compound 1 | 2 | KV37 | 1 | 25 | 20 | 40 | 85.4 |
| Example 9 | Compound 1 | 2 | KV37 | 1 | 25 | 20 | 40 | 85.4 |
| Example 10 | Compound 1 | 2 | KV37 | 1 | 35 | 20 | 25 | 80.4 |
| Example 11 | Compound 1 | 2 | KV37 | 1 | 35 | 5 | 25 | 65.4 |
| Example 12 | Compound 1 | 2 | KV37 | 1 | 35 | 20 | 25 | 80.4 |
| Example 13 | Compound 1 | 2 | KV37 | 1 | 35 | 20 | 25 | 80.4 |
| Example 14 | | 0 | KV37 | 1 | 35 | 20 | 80 | 135.4 |
| Comp. Exam. 1 | | 0 | KV37 | 1 | — | — | — | — |
| Comp. Exam. 2 | | 0 | KV37 | 1 | — | — | — | — |
| Comp. Exam. 3 | Compound 1 | 2 | KV37 | 1 | 42 | 20 | 40 | 102.4 |
| Comp. Exam. 4 | Compound 1 | 2 | KV37 | 1 | 42 | 20 | 40 | 102.4 |
| Comp. Exam. 5 | Compound 1 | 2 | KV37 | 1 | 35 | 20 | 40 | 95.4 |
| Comp. Exam. 6 | | 0 | KV37 | 1 | — | — | — | — |
| Comp. Exam. 7 | | 0 | KV37 | 1 | 46 | 20 | 40 | 106.4 |
| Comp. Exam. 8 | | 0 | KV37 | 1 | 35 | 20 | 40 | 95.4 |
| Comp. Exam. 9 | Compound 1 | 2 | KV37 | 1 | 39 | 20 | 40 | 99.4 |
| Comp. Exam. 10 | Compound 1 | 2 | KV37 | 1 | 35 | 20 | 40 | 95.4 |

In the table, B represents the acylated rate (%) of the OH groups in a cellulose acylate, and A represents the esterified rate of the OH groups in a sugar ester compound.

The amount (% by mass) of each component is based on 100 parts by mass of the cellulose acylate.

### <Sugar Ester Compound>

SucBA represents sucrose benzoate. The number posterior to SucBA represents the degree of substitution of the OH groups in the pyranose structure and the furanose structure of a sugar ester compound. For example, SucBA4.5 indicates sucrose benzoate having a degree of OH group substitution of 4.5 in the pyranose structure and the furanose structure of the sugar ester compound. Sugar ester compounds were synthesized as follows.

A four-necked flask provided with a stirrer, a reflux condenser, a thermometer, and a nitrogen gas inlet tube was charged with 34.2 g (0.1 mol) of sucrose, 180.8 g (0.8 mol) of benzoic anhydride, and 379.7 g (4.8 mol) of pyridine. The mixture was heated with stirring and bubbling of nitrogen gas from the nitrogen gas inlet tube for esterification at 70° C. for 5 hours. The pressure in the flask was reduced to 4×10² Pa or less, and excess pyridine was distilled out at 60° C. The pressure in the flask was then reduced to 1.3×10 Pa or less, and the flask was heated up to 120° C. to distill benzoic anhydride and the majority of the produced benzoic acid. Subsequently, 1 L of toluene and 300 g of an aqueous 0.5% by mass of sodium carbonate solution were added to the flask. The mixture was stirred at 50° C. for 30 minutes and was then left to stand, and the toluene layer was collected. The collected toluene layer was washed with 100 g of water at ordinary temperature for 30 minutes. The toluene layer was collected, and toluene was distilled out under a reduced pressure (4×10²² Pa or less) at 60° C. to yield a mixture of SucBA3, SucBA4, SucBA4.5, SucBA5, and SucBA5.5. Analytical results by HPLC and LC-MASS of the resulting mixture demonstrated that the mixture consisted of 7% by mass of SucBA3, 58% by mass of SucBA4, 23% by mass of SucBA4.5, 9% by mass of SucBA5, and 3% by mass of SucBA5.5. A part of the mixture was purified by silica gel column chromatography to give SucBA3, SucBA4, SucBA4.5, SucBA5, and SucBA5.5 each having a purity of 100%.

### <Eater Oligomer>

An oligomer mixture was prepared through a reaction of PG and TPA giving the following compositions. After stirring, mBA and/or BA was added to the mixture to block the prepared oligomers. The mixture of the blocked oligomers was subjected to purification to prepare mBA/PG/TPA/PG/mBA and BA/PG/TPA/PG/BA.

In the compositions, mBA represents methyl benzoate, PG represents propylene glycol, TPA represents terephthalic acid, and BA represents benzoate. The following oligomers were used:

mBA-(PG-TPA)n-PG-mBA: n is 0 to 2, and

BA-(PG-TPA)n-PG-BA: n is 0 to 2.

Aliphatic ester oligomer (molecular weight: 1000): prepared by reacting ethylene glycol (EG) with adipic acid (AA) and blocking the terminals with OAc (Ac: acetyl group).

### <Discotic Compound>

Compound 1 in the table is the following compound.

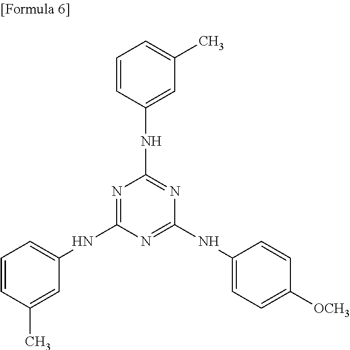 [SMILES: COc1ccc(Nc2nc(Nc3cccc(C)c3)nc(Nc3cccc(C)c3)n2)cc1]

### <Stripping Enhancer>

K37V represents a stripping enhancer available under a trade name Poem K-37V manufactured by Riken Vitamin Co., Ltd.

### <Second Protective Film of Polarizing Plate>

Films having thickness of 40 μm, 25 μm, and 80 μm shown in the table are the following second protective films of the polarizing plate F1, F2, and F3, respectively.

### (Production of Second Protective Films of the Polarizing Plate F1, Thickness: 40 μm)

In accordance with the process described in Example 1 (sample 101) of Japanese Patent Laid-Open No. 2012-31313, second protective film of the polarizing plate F1 having a thickness of 40 μm and containing 5.25 parts by mass of a mixture of aromatic sugar ester compounds of Formulae (I) and (II) and 1.75 parts by mass of an aliphatic sugar ester compound of Formula (III) shown in the patent literature relative to 100 parts by mass of cellulose acylate was formed.

### (Production of Second Protective Film of the Polarizing Plate F2, Thickness: 25 μm)

### (Production of Cellulose Acylate Dope)

The composition shown below was placed in a mixing tank and was stirred to dissolve the individual components to prepare a cellulose acetate solution. The following solvent composition was used in each solution, and a cellulose acetate dope was prepared by controlling the cotton concentration to 17% by mass.

Methylene chloride (first solvent): 92 parts by mass

Methanol (second solvent): 8 parts by mass

The following matting agent dispersion in an amount of 3.6 parts by mass was further added to the cellulose acylate dope.

The amounts of the cotton and the additives in the cellulose acylate dope were adjusted as follows:

Cellulose acylate having a degree of substitution of 2.88: 100 parts by mass,

UV-1: 1.8 parts by mass,

UV-2: 0.8 parts by mass, and

P-1: 12 parts by mass.

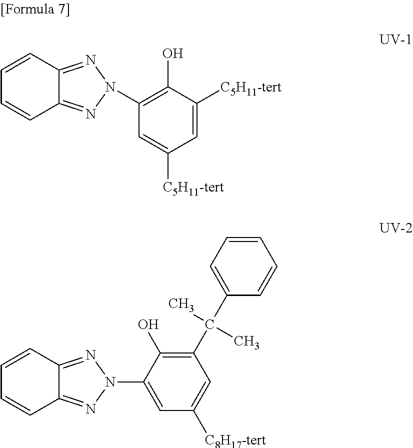

P-1 is a mixture of triphenyl phosphate (TPP) and biphenyldiphenyl phosphate (BDP) at a mass ratio of 2:1.

### (Matting Agent Dispersion)

Silica particle dispersion (average particle diameter: 16 nm): 0.7 parts by mass

Methylene chloride (first solvent): 75.5 parts by mass

Methanol (second solvent): 6.5 parts by mass

Dope prepared as above: 17.3 parts by mass

### (Production of Cellulose Acylate Film)

The cellulose acylate dope was cast from a casting outlet on a drum at 20° C. The resulting film was peeled off at a solvent content of about 20% by mass, was fixed at both ends in the width direction of the film with tenter clips, and was dried. The film was further dried while being transported between the rollers of a heating apparatus to produce a cellulose acylate film, which was used as second protective film of the polarizing plate F2.

### (Second Protective Film of the Polarizing Plate F3, Thickness: 80 μm)

Fujitac TD80UL (manufactured by Fujifilm Corporation) was used as second protective film of the polarizing plate F3.

### <Production of Polarizing Plate Sample>

The surfaces of the films of Examples and Comparative Examples produced above were alkali-saponified. Each film was immersed in an aqueous 1.5 N sodium hydroxide solution at 55° C. for 2 minutes and was washed in a water washing tank at room temperature, followed by neutralization with 0.1 N sulfuric acid at 30° C. The films were washed again in a water washing tank at room temperature and were then dried in hot air at 100° C.

A rolled poly(vinyl alcohol) film was successively stretched to five times in an aqueous iodine solution and was dried to give a polarizer. The thickness of each polarizer is shown in the following table. The alkali-saponified first and second protective films of the polarizing plate of each Example or Comparative Example were bonded to the polarizer with an adhesive of an aqueous 3% poly(vinyl alcohol) (PVA-117H, manufactured by Kuraray Co., Ltd.) solution such that the saponified surfaces were disposed on both sides of the polarizer. Polarizing plates each consisting of a first protective film of the polarizing plate, a polarizer, and a second protective film of the polarizing plate bonded in this order were thereby prepared. The first protective film of the polarizing plate and the second protective film of the polarizing plate were disposed such that the MD directions were parallel to the absorption axis of the polarizer. The thickness of the adhesive was 0.2 μm.

### <Production of Liquid Crystal Display>

The polarizing plates and retardation plates were removed from both sides of a VA mode liquid crystal TV (LC-46LX3, manufactured by Sharp Corporation) to obtain a liquid crystal cell. As the structure shown in FIG. 1 (the upper face is the front side), the liquid crystal display of each Example or Comparative Example was produced by bonding, with an adhesive, an outer protective film (not shown), a polarizer 11, a film 14 of each Example or Comparative Example shown in the following table (cellulose acylate film on the rear side), a liquid crystal cell 13 (the above-mentioned VA liquid crystal cell), a film 15 of each Example or Comparative Example shown in the following table (cellulose acylate film on the front side), a polarizer 12, and an outer protective film (not shown) in this order. The two polarizing plates were disposed such that the absorption axes were orthogonal to each other.

### (Panel Unevenness Test)

The produced liquid crystal displays were left to stand in an environment of −20° C. for 5 hours and then an environment of 40° C. and 90% RH for 8 hours and were then continuously lit for 12 hours. The unevenness was then observed from the front and oblique directions. The results were evaluated as follows.

### (Front Unevenness)

A: no visual unevenness
B: slight visual unevenness
C: high visual unevenness

### (Oblique Unevenness)

A: no visual unevenness
B: slight visual unevenness
C: high visual unevenness

TABLE 2

| | First | First | | | |
|---|---|---|---|---|---|
| | protective | protective | Water | Evaluation | Evaluation |
| | film | film | contract test | of front | of oblique |
| | Re(590) | Rth(590) | ΔRth | unevenness | unevenness |
| Example 1 | 50 | 110 | −1 nm | A | A |
| Example 2 | 50 | 110 | −2 nm | A | A |
| Example 3 | 50 | 110 | −1 nm | A | A |
| Example 4 | 50 | 110 | −1 nm | A | A |
| Example 5 | 50 | 110 | 3 nm | A | B |
| Example 6 | 50 | 110 | 1 nm | A | A |
| Example 7 | 50 | 110 | 2 nm | A | B |
| Example 8 | 50 | 110 | 3 nm | A | B |
| Example 9 | 50 | 110 | 1 nm | A | A |
| Example 10 | 50 | 110 | 1 nm | A | A |
| Example 11 | 50 | 110 | 1 nm | A | A |
| Example 12 | 50 | 110 | 2 nm | A | A |
| Example 13 | 50 | 110 | 2 nm | A | A |
| Example 14 | 50 | 110 | −1 nm | B | A |
| Comp. Exam. 1 | — | — | — | — | — |
| Comp. Exam. 2 | — | — | — | — | — |
| Comp. Exam. 3 | 50 | 110 | 4 nm | C | B |
| Comp. Exam. 4 | 50 | 110 | 8 nm | C | C |
| Comp. Exam. 5 | 50 | 110 | 7 nm | C | C |
| Comp. Exam. 6 | — | — | — | — | — |
| Comp. Exam. 7 | 50 | 110 | 1 nm | C | C |
| Comp. Exam. 8 | 50 | 110 | 6 nm | C | C |
| Comp. Exam. 9 | 45 | 100 | 8 nm | B | C |
| Comp. Exam. 10 | 45 | 100 | 9 nm | C | C |

The cellulose acylate films of the present invention (Examples 1 to 14) show small changes in Rth after the water contact test and invisible front and oblique unevenness.

The sample (Comparative Example 5) not containing a sugar ester compound shows a large change in Rth after the water contact test and visible front and oblique unevenness.

The sample (Comparative Example 4) containing an aliphatic ester oligomer instead of the aromatic ester oligomer shows a large change in Rth after the water contact test and visible front and oblique unevenness.

The sample (Comparative Example 8) not containing an aromatic ester oligomer and not containing any alternative shows a large change in Rth after the water contact test and visible front and oblique unevenness.

When the samples (Comparative Examples 1 and 2) including a cellulose acylate film not satisfying a ratio A/B of 0.55 to 0.95 is used, the film became bleached. Low compatibility of the cellulose acylate with additives is thought to be the cause of the bleaching.

The samples (Comparative Examples 3, 4, and 7) including a cellulose acylate film having a thickness outside the range of 20 to 39 μm show large changes in Rth after the water contact test and visible front and oblique unevenness.

In the sample (Comparative Example 6) including a film of a cellulose acylate having a total degree of acyl substitution of less than 2.0 as the protective film of the polarizing plate, the film was not peeled from the support.

The samples (Comparative Examples 6 and 7) including a film of a cellulose acylate having a total degree of acyl substitution of higher than 2.35 as the protective film of the polarizing plate show large changes in Rth after the water contact test and visible front and oblique unevenness.

### EXPLANATION OF SIGNS

11 polarizer
12 polarizer
13 liquid crystal cell
14 cellulose acylate film in each Example or Comparative Example
15 cellulose acylate film in each Example or Comparative Example

What is claimed is:

1. A cellulose acylate film comprising a cellulose acylate whose total degree of acyl substitution is 2.0 to 2.35, a sugar ester compound and an aromatic ester oligomer, and having a thickness of 20 to 39 μm;
wherein the sugar ester compound has one to six of at least one kind of pyranose structure(s) and furanose structure(s);
OH groups of the pyranose structure(s) and the furanose structure(s) are partially esterified with an aromatic organic acid; and
a ratio A/B is in the range from 0.55 to 0.95;
wherein A is an esterified rate of the OH groups in the sugar ester compound, and B is an acylated rate of the OH groups in the cellulose acylate.

2. The cellulose acylate film according to claim 1, wherein the sugar ester compound is a sucrose benzoate having a degree of OH group substitution of 4 to 5 in the pyranose structure(s) and the furanose structure(s).

3. The cellulose acylate film according to claim 1, wherein the cellulose acylate is cellulose acetate.

4. The cellulose acylate film according to claim 1, which has an absolute value of 5 nm or less in Rth change at a wavelength of 550 nm after a water contact test;
wherein, in the water contact test, the film is immersed in water at 40° C. for 12 hours; waterdrops on the surfaces of the film are wiped off; and the film is dried in air and is then left to stand at 25° C. and 60% RH for 24 hours.

5. The cellulose acylate film according to claim 1, wherein the aromatic ester oligomer is a compound of terephthalic acid and propylene glycol, the compound having a molecular weight of 300 to 5000.

6. The cellulose acylate film according to claim 1, further satisfying Formula (2):
100 nm≦Rth(550)≦300 nm Formula (2):
wherein Rth(550) represents a thickness-direction retardation at a wavelength of 550 nm.

7. The cellulose acylate film according to claim 2, wherein the cellulose acylate is cellulose acetate.

8. The cellulose acylate film according to claim 2, which has an absolute value of 5 nm or less in Rth change at a wavelength of 550 nm after a water contact test,
wherein, in the water contact test, the film is immersed in water at 40° C. for 12 hours; waterdrops on the surfaces of the film are wiped off; and the film is dried in air and is then left to stand at 25° C. and 60% RH for 24 hours.

9. The cellulose acylate film according to claim 2, wherein the aromatic ester oligomer is a compound of terephthalic acid and propylene glycol components, the compound having a molecular weight of 300 to 5000.

10. The cellulose acylate film according to claim 2, further satisfying Formula (2):
100 nm≦Rth(550)≦300 nm Formula (2):
wherein Rth(550) represents a thickness-direction retardation at a wavelength of 550 nm.

11. The cellulose acylate film according to claim 3, which has an absolute value of 5 nm or less in Rth change at a wavelength of 550 nm after a water contact test,
wherein, in the water contact test, the film is immersed in water at 40° C. for 12 hours; waterdrops on the surfaces of the film are wiped off; and the film is dried in air and is then left to stand at 25° C. and 60% RH for 24 hours.

12. The cellulose acylate film according to claim 3, wherein the aromatic ester oligomer is a compound of terephthalic acid and propylene glycol components, the compound having a molecular weight of 300 to 5000.

13. The cellulose acylate film according to claim 3, further satisfying Formula (2):
100 nm≦Rth(550)≦300 nm Formula (2):
wherein Rth(550) represents a thickness-direction retardation at a wavelength of 550 nm.

14. The cellulose acylate film according to claim 4, wherein the aromatic ester oligomer is a compound of terephthalic acid and propylene glycol components, the compound having a molecular weight of 300 to 5000.

15. The cellulose acylate film according to claim 4, further satisfying Formula (2):
100 nm≦Rth(550)≦300 nm Formula (2):
Wherein Rth(550) represents a thickness-direction retardation at a wavelength of 550 nm.

16. The cellulose acylate film according to claim 5, further satisfying Formula (2):
100 nm≦Rth(550)≦300 nm Formula (2):
wherein Rth(550) represents a thickness-direction retardation at a wavelength of 550 nm.

17. A polarizing plate comprising: a cellulose acylate film according to claim 1.

18. A polarizing plate comprising:
a cellulose acylate film according to claim 1;
a protective film having a thickness of 10 to 40 μm; and
a polarizer having a thickness of 3 to 20 μm disposed between the cellulose acylate film and the protective film,
wherein the polarizing plate has a total thickness of 40 to 100 μm.

19. A liquid crystal display comprising: a polarizing plate according to claim 17.

20. A liquid crystal display comprising: a polarizing plate according to claim 17; and a glass plate having a thickness of 50 to 500 μm.
